(19) United States
(12) Patent Application Publication
(10) Pub. No.: US 2017/0205933 A1
(43) Pub. Date: Jul. 20, 2017

(54) TOUCH SENSOR AND METHOD OF DRIVING THE SAME

(71) Applicants: Samsung Display Co., Ltd., Yongin-si (KR); UNIST (ULSAN NATIONAL INSTITUTE OF SCIENCE AND TECHNOLOGY), Ulsan (KR)

(72) Inventors: Jun Il Kwon, Yongin-si (KR); Franklin Bien, Ulsan (KR); Jae Joon Kim, Ulsan (KR); Sanghyun Heo, Ulsan (KR); Hyunggun Ma, Ulsan (KR)

(21) Appl. No.: 15/255,581

(22) Filed: Sep. 2, 2016

(30) Foreign Application Priority Data
Jan. 18, 2016 (KR) 10-2016-0006036

(51) Int. Cl. G06F 3/041; G06F 3/044

(52) U.S. Cl. CPC G06F 3/0416; G06F 3/044; G06F 2203/04104

(57) ABSTRACT

A touch sensor including a touch sensing unit including drive electrodes and sensing electrodes, a drive signal generation unit that applies parallel drive signals to the drive electrodes, differential amplifiers that receive sensed output values output from the sensing electrodes according to the parallel drive signals and a reference output value, and a touch processing unit that determines an occurrence of a touch according to differential output values of the differential amplifiers.

### CROSS-REFERENCE TO RELATED APPLICATION

This application claims priority from and the benefit of Korean Patent Application No. 10-2016-0006036, filed on Jan. 18, 2016, which is hereby incorporated by reference for all purposes as if fully set forth herein.

### BACKGROUND

Field

Exemplary embodiments relate to a touch sensor and a method of driving the same.

Discussion of the Background

A display device may be utilized in a computer, a monitor, a television, a cellular phone, or the like, which are widely used today. A display device configured to display images using digital data may include a cathode ray tube display device, a liquid crystal display (LCD) display device, a plasma display panel (PDP) display device, an organic light emitting device (OLED) display device, and the like. As a resolution and the size of a display device increase, the amount of data transmission and transmission speed thereof may be increased.

A touch sensor may be an input device, on which a hand of a human or an object may select a command that is displayed on an image display device or the like, and input a command of a user. To this end, a touch sensor may be disposed in a front side of the image display device, and convert energy generated in a touched location into an electric signal. Accordingly, a command selected at the touched location may be input as an input signal. The touch sensor may be used to operate a display device, rather than an independent input device connected to an image display device, such as a key board or a mouse. Thus, the touch sensor usage is gradually expanding.

A method of operating a touch sensor may include a resistance film method, a light sensing method, a capacitance method, or the like. The capacitance method may have high durability and sharpness, and may be capable of multi-touch recognition and proximity touch recognition, as compared to the resistance film method. Thus, the capacitance method may be applied to various applications.

In the capacitance method, the multi-touch recognition may be realized by using a self-capacitance method and a mutual capacitance method. Among these methods, the mutual capacitance method may recognize a touched location by detecting a change of capacitance formed at a sensing cell (node) disposed on a touched surface, by an electric field of a human body or the like, when at least one pointer, such as a human finger, touches the touch sensor.

For example, a pulse generator may apply a drive signal to a driving line of the touch sensor. The drive signal may be a predetermined voltage. In addition, a value proportional to a mutual capacitance value between a drive electrode and a sensing line may be output. The output value may be input to, for example, a charge amplifier, which is then amplified and output as an analog value. The output analog value may be converted into a digital signal by an analog-to-digital converter (ADC). A touch processing unit (touch control unit) may receive the converted digital signal and identify a touched point using the value.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a touch sensor having a high signal to noise ratio (SNR). Exemplary embodiments also provide a method of recognizing a fingerprint pattern by sensing signals of each electrode at high speed. Exemplary embodiments further provide a touch sensor with accurate touch recognition, which is obtained by removing common noise, such as display noise, lamp noise, or charger noise.

Additional aspects will be set forth in the detailed description which follows, and, in part, will be apparent from the disclosure, or may be learned by practice of the inventive concept.

An exemplary embodiment of the present invention discloses a touch sensor including a touch sensing unit including drive electrodes and sensing electrodes, a drive signal generation unit configured to apply parallel drive signals to the drive electrodes, differential amplifiers configured to receive sensed output values output from the sensing electrodes according to the parallel drive signals, and a reference output value, and a touch processing unit configured to determine an occurrence of a touch according to differential output values of the multiple differential amplifiers.

An exemplary embodiment of the present invention also discloses a method of driving a touch sensor including putting parallel drive signals to drive electrodes on a touch sensing unit, outputting sensed output values according to the parallel drive signals and a reference output value to differential amplifies, and determining an occurrence of a touch according to differential output values of the differential amplifiers.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a diagram illustrating a capacitive touch sensor, according to an exemplary embodiment of the present invention.

FIG. 2 is a diagram illustrating a capacitive touch sensor, according to an exemplary embodiment of the present invention.

FIG. 3 is a diagram illustrating an operating method of a fingerprint recognition touch sensor, according to an exemplary embodiment of the present invention.

FIG. 4 is a diagram illustrating sensing electrodes and drive electrodes of the fingerprint recognition touch sensor, according to an exemplary embodiment of the present invention.

FIG. 5 is a diagram illustrating a touch sensor, according to an exemplary embodiment of the present invention.

FIG. 6 is a diagram illustrating a touch sensor, according to an exemplary embodiment of the present invention.

FIG. 7 is a diagram illustrating a differential sensing method, according to an exemplary embodiment of the present invention.

FIG. 8A and FIG. 8B are diagrams illustrating a parallel drive method, according to an exemplary embodiment of the present invention.

FIG. 9 is a diagram illustrating a differential parallel sensing method, according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, a sensing electrode, a sensing line, a sensing wire, an Rx electrode, a receiver electrode, an Rx pad, an Rx cell, an Rx pattern cell, an Rx IC pad, and the like, may be used interchangeably with each other. In addition, a drive electrode, a drive line, a drive wire, a Tx electrode, a transmitter electrode, a Tx pad, a Tx cell, a Tx pattern cell, a Tx IC pad, and the like, may be used interchangeably with each other.

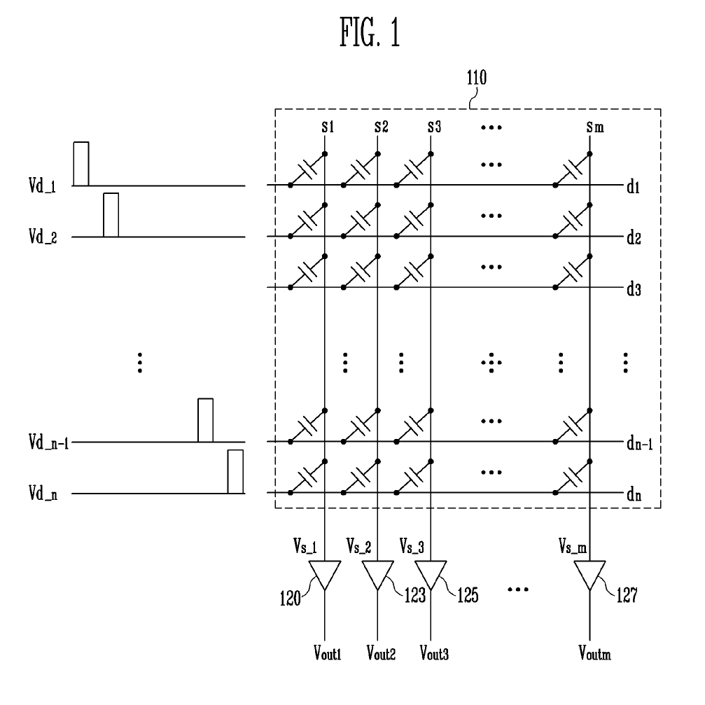

FIG. 1 is a diagram illustrating a capacitive touch sensor according to an exemplary embodiment of the present invention.

Referring to FIG. 1, the touch sensor may include a touch sensing unit 110. The touch sensing unit 110 includes multiple drive electrodes d1 to dn and multiple sensing electrodes s1 to sm.

The multiple drive electrodes d1 to dn may be arranged in parallel with each other in a horizontal direction (row direction) of the touch sensing unit 110, and the multiple sensing electrodes s1 to sm may be arranged in parallel with each other in a vertical direction (column direction) of the touch sensing unit 110. More particularly, the touch sensing unit 110 may be configured by an array structure, in which the multiple drive electrodes d1 to dn respectively intersect the multiple sensing electrodes s1 to sm.

Predetermined drive signals Vd_1 to Vd_n may be applied to the respective drive electrodes d1 to dn. The predetermined drive signals Vd_1 to Vd_n may have predetermined voltages, for example, AC voltages. In this manner, respective sensing capacitances may be formed between the multiple drive electrodes d1 to dn, to which the drive signals Vd_1 to Vd_n are applied, and the multiple sensing electrodes s1 to sn corresponding thereto, according to the predetermined drive signals Vd_1 to Vd_n . For example, a first sensing capacitance may be formed between the first drive electrode d1 and the first sensing electrode s1, and an (n-m)^{th} sensing capacitance may be formed between the n^{th} drive electrode dn and the m^{th} sensing electrode sm. Hereinafter, for convenience of description, a sensing capacitance, a mutual sensing capacitance, a mutual capacitance, or the like may be referred to as the sensing capacitance.

Sensing amplifiers 120, 123, 125, and 127 disposed at the end portions of the multiple sensing electrodes s1 to sn may output output values corresponding to the magnitudes of the sensing capacitances, as the sensed output values Vout1 to Voutm. For example, the first sensing amplifier 120 may output the output values corresponding to the magnitudes of the (1-1)^{th} to (1-n)^{th} sensing capacitances formed between the first sensing electrode s1 and the first to n^{th} drive electrodes d1 to dn, as the first sensed output value Vout1. The m^{th} sensing amplifier 127 may output the m^{th} sensed output value Voutm.

In this manner, in the capacitive touch sensor of FIG. 1, the drive signals Vd_1 to Vd_n may be applied to the drive electrodes d1 to dn by a time-interleaving method. More particularly, the drive signals Vd_1 to Vd_n may be transmitted to the drive electrodes d1 to dn at a predetermined time interval, and the drive electrodes d1 to dn may be sensed one-by-one, at the multiple sensing electrodes s1 to sm. For example, the first drive signal Vd1 may be applied to the first drive electrode d1 at first time. Accordingly, the (1-1)^{th} to (m-1)^{th} sensing capacitances may be formed only between the first drive electrode d1 and the first to m^{th} sensing electrodes s1 to sm. Hence, the first to m^{th} sensing amplifiers 120, 123, 125, and 127 may output the output values corresponding to the magnitudes of the (1-1)^{th} to (m-1)^{th} sensing capacitances, according to the first drive signal Vd_1 at the first time. In this manner, the n^{th} drive signal Vdn is applied to the n^{th} drive electrode dn at n^{th} time. Accordingly, the (1-n)^{th} to (m-n)^{th} sensing capacitances may be formed only between the n^{th} drive electrode dn and the first to m^{th} sensing electrodes s1 to sm. Hence, the first to m^{th} sensing amplifiers 120, 123, 125, and 127 may output the output values corresponding to the magnitudes of the (1-n)^{th} to (m-n)^{th} sensing capacitances according to the n^{th} drive signal Vd_n at the n^{th} time.

At this time, if a touch event occurs at a predetermined region of the touch sensing unit 110, the sensing capacitance between the sensing electrode and the drive electrode disposed at the touched region may be changed. For example, if a touch event occurs at a location of the third sensing electrode s3 and the third drive electrode d3 of the touch sensing unit 110, the magnitude of the (3-3)^{th} sensing capacitance formed between the third sensing electrode s3 and the third drive electrode d3 may be changed. Accordingly, the third sensed output value Vout3, which is output from the third sensing amplifier 125 may be changed, as compared to when a touch event does not occur.

The sensed output values Vout1 to Voutm, which are output from the respective sensing amplifiers 120, 123, 125, and 127, are input to a receiving unit (not illustrated). The receiving unit (not illustrated) may calculate the sensed capacitance values between the respective drive electrodes d1 to dn and the multiple sensing electrodes s1 to sm using the received values, and identify a touched location using the calculated values. The receiving unit (not illustrated) may include an analog-to-digital converter (ADC) (not illustrated), and convert the analog sensed output values Vout1 to Voutm, which are output from the respective sensing amplifiers 120, 123, 125, and 127, into digital signals. A touch processing unit (touch control unit) (not illustrated) of the receiving unit (not illustrated) may alternatively identify a touched location using the values converted into the digital signals.

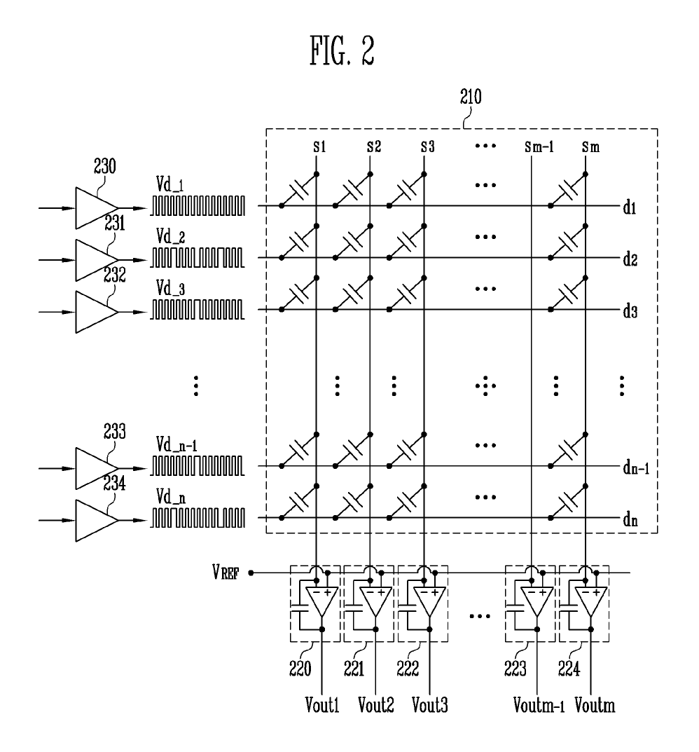

FIG. 2 is a diagram illustrating a capacitive touch sensor according to an exemplary embodiment of the present invention.

Referring to FIG. 2, the touch sensor may include a touch sensing unit 210. The touch sensing unit 210 includes multiple drive electrodes d1 to dn and multiple sensing electrodes s1 to sm.

The multiple drive electrodes d1 to dn may be arranged in parallel with each other in a horizontal direction (row direction) of the touch sensing unit 210, and the multiple sensing electrodes s1 to sm may be arranged in parallel with each other in a vertical direction (column direction) of the touch sensing unit 210. More particularly, the touch sensing unit 210 may be configured by an array structure, in which the multiple drive electrodes d1 to dn respectively intersect the multiple sensing electrodes s1 to sm.

Drive signal generation units 230 to 234 may apply predetermined drive signals Vd_1 to Vd_n to the respective drive electrodes d1 to dn. The predetermined drive signals Vd_1 to Vd_n may have predetermined voltages, for example, AC voltages. The drive signal generation units 230 to 234 may be code generators. In FIG. 2, the drive signal generation units 230 to 234 may respectively apply the drive signals Vd_1 to Vd_n to the respective drive electrodes d1 to dn. Alternatively, one drive signal generation unit may apply the drive signals Vd_1 to Vd_n to multiple drive electrodes d1 to dn.

Sensing capacitances may be formed between the drive electrodes d1 to dn, to which the drive signals Vd_1 to Vd_n are applied, and the multiple sensing electrodes s1 to sm corresponding thereto, according to the predetermined drive signals Vd_{—1} to Vd_n. For example, a first sensing capacitance may be formed between the first drive electrode d1 and the first sensing electrode s1, and an (n-m)^{th} sensing capacitance may be formed between the n^{th} drive electrode dn and the m^{th} sensing electrode sm.

Sensing amplifiers 220 to 224 disposed at the end portion of the multiple sensing electrodes s1 to sm may output output values corresponding to the magnitudes of the sensing capacitances, as the sensed output values Vout1 to Voutm. For example, the first sensing amplifier 220 may output the output values corresponding to the magnitudes of the (1-1)^{th} to (1-n)^{th} sensing capacitances, which are formed between the first sensing electrode s1 and the first to n^{th} drive electrodes d1 to dn, as the first sensed output value Vout1. The m^{th} sensing amplifier 224 may output the m^{th} sensed output value Voutm.

In this manner, in the capacitive touch sensor illustrated in FIG. 2, the drive signals Vd_1 to Vd_n may be applied to the drive electrodes d1 to dn by a parallel driving method. More particularly, modulated drive signals may be simultaneously transmitted to the multiple drive electrodes d1 to dn. In addition, sensed output values Vout1 to Voutm, which may be mixed values of the sensing capacitances respectively formed between the drive electrodes d1 to dn and the sensing electrodes s1 to sm, may be output. Accordingly, the multiple sensing electrodes s1 to sm may sense the multiple drive electrodes d1 to dn at one time. For example, at the first time, the first drive signal Vd_1 may be transmitted to the first drive electrode d1, and the second drive signal Vd_2 may be transmitted to the second drive electrode d2. In addition, the n^{th} drive signal Vd_n may be transmitted to the n^{th} drive electrode dn. Accordingly, the (1-1)^{th} to (m-1)^{th} sensing capacitances may be formed between the first drive electrode d1 and the first to m^{th} sensing electrodes s1 to sm, and the (1-2)^{th} to (m-2)^{th} sensing capacitances may be formed between the second drive electrode d2 and the first to m^{th} sensing electrodes s1 to sm. In addition, the (1-n)^{th} to (m-n)^{th} sensing capacitances may be formed between the n^{th} drive electrode dn and the first to m^{th} sensing electrodes s1 to sm. Hence, at the first time, the sensed output values Vout1 to Voutm, which may be mixed values of the sensing capacitances respectively formed between the drive electrodes d1 to dn and the sensing electrodes s1 to sm, may be output. In addition, at the second time, the sensed output values Vout1 to Voutm, which may be mixed values of the sensing capacitances respectively formed between the drive electrodes d1 to dn and the sensing electrodes s1 to sm, may also be output.

At this time, if a touch event occurs at a predetermined region of the touch sensing unit 210, the sensing capacitance formed between the sensing electrode and the drive electrode disposed at the touched region may be changed. For example, if a touch event occurs at a location of the third sensing electrode s3 and the third drive electrode d3 of the touch sensing unit 210, the magnitude of the (3-3)^{th} sensing capacitance formed between the third sensing electrode s3 and the third drive electrode d3 may be changed. Accordingly, the third sensed output value Vout3 output from the third sensing amplifier 222 may be changed, as compared to when a touch event does not occur.

The sensed output values Vout1 to Voutm, which are output from the respective sensing amplifiers 220 to 224, are input to a receiving unit (not illustrated). The receiving unit (not illustrated) may calculate the sensed capacitance values between the respective drive electrodes d1 to dn and the multiple sensing electrodes s1 to sm, using the received values and the drive signals Vd_1 to Vd_n, which are input to the respective drive electrode d1 to dn, and identify a touched location using the calculated values. The receiving unit (not illustrated) may include an analog-to-digital converter (ADC) (not illustrated), and convert the analog sensed output values Vout1 to Voutm, which are output from the respective sensing amplifiers 120, 123, 125, and 127, into digital signals. A touch processing unit (touch control unit) (not illustrated) of the receiving unit (not illustrated) may alternatively calculate the respective values of the sensing amplifiers, by demodulating the values that are converted into digital signals, and identify a touched location.

The sensing amplifiers 220 to 224 may be switched capacitor amplifiers. In addition, as illustrated in FIG. 2, the respective sensing amplifiers 220 to 224 may use a single ended output having one output. At this time, a current output from a single electrode may be output, by using the single ended output of the switched capacitor amplifier. For example, the drive signal generation units 230 to 234 may transmit the drive signals having rising edges and falling edges. When the drive signal having rising edge is input, a first amplifier may output a signal, and when the drive signal having falling edge is input, a second amplifier may output a signal. In this manner, two switched capacitor amplifiers may output differential output signals, using the rising edge and the falling edge of the signal output from a single line. Since sampling times are different from each other, however, it may be difficult to remove common noise in the drive electrodes d1 to dn and the multiple sensing electrodes s1 to sm of the entire touch sensor.

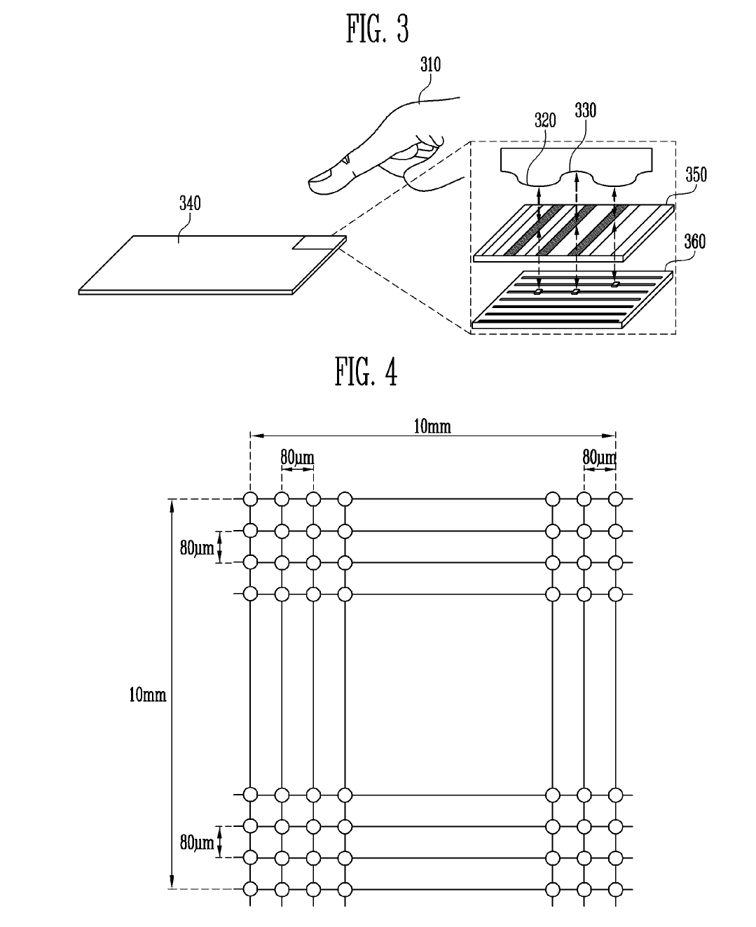

FIG. 3 is a diagram illustrating an operating method of a fingerprint recognition touch sensor.

Referring to FIG. 3, a fingerprint recognition touch sensor 340 may include a first layer 350, on which sensing electrodes are disposed in parallel with each other in a direction perpendicular to the drive electrodes, and a second layer 360, on which the drive electrodes are disposed in parallel with each other. A configuration and operation of the drive electrodes and the sensing electrodes according to the present exemplary embodiment are substantially similar to those illustrated with references to FIG. 1 and FIG. 2, and thus, duplicated description thereof will be omitted.

A fingerprint of a human hand 310 includes a ridge 320 and a valley 330. If the hand 310 touches the touch sensor 340, the ridge 320 may contact a sensing electrode of the first layer 350, as illustrated in FIG. 3, but the valley 330 may not contact the sensing electrode of the first layer 350. A touch processing unit (not illustrated) may recognize the fingerprint, by sensing a difference between a capacitance between the ridge 320 and the sensing electrode and a capacitance between the valley 330 and the sensing electrode. Accordingly, in order for the touch sensor to recognize the fingerprint, a distance between the sensing electrodes may be less than a period between the ridge 320 and the valley 330 of the fingerprint. In addition, a distance between the drive electrodes may be less than a period between the ridge 320 and the valley 330 of the fingerprint. For example, if the period between the ridge 320 and the valley 330 is approximately 500 μm, fingerprint recognition may be implemented by forming a distance between the sensing electrodes and a distance between the drive electrodes less than 500 μm.

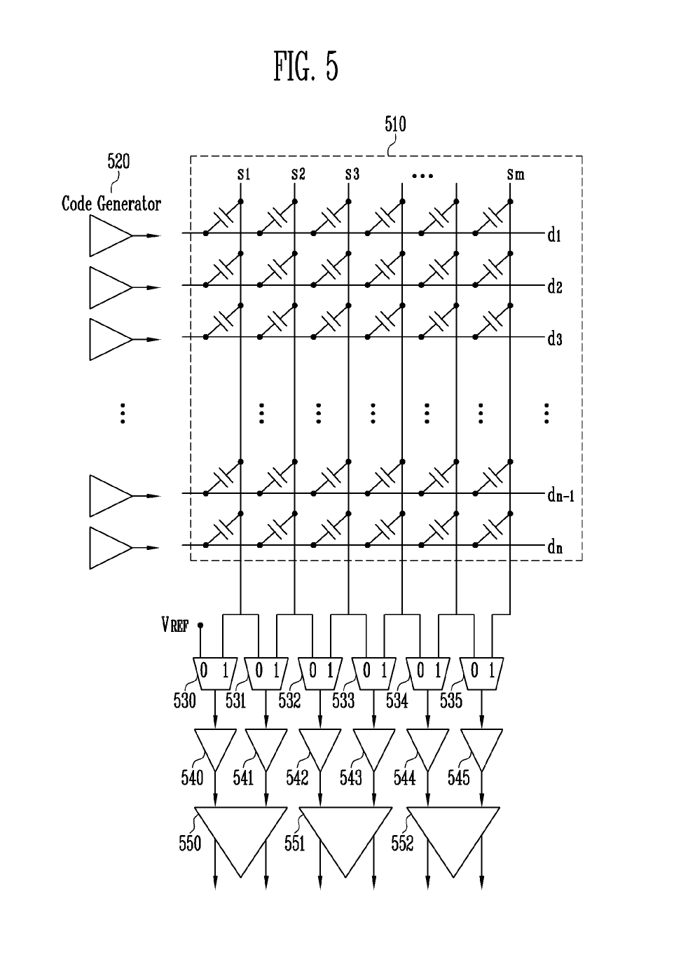

FIG. 4 is a diagram illustrating sensing electrodes and drive electrodes of the fingerprint recognition touch sensor.

Referring to FIG. 4, a distance between sensing electrodes and a distance between drive electrodes may be less than a period between a ridge and a valley. For example, the period between the ridge and the valley is approximately 500 μm, and the distance between the respective electrodes may be approximately 80 μm.

When an intersection point of the sensing electrode and the drive electrode is referred to as a dot, distribution of the dots may be 322 dot per inch (dpi) or 12.67 dot per mm. When a size of the fingerprint recognition touch sensor is approximately 10 mm×10 mm, approximately 126 (=12.67×10) dots are formed on the respective lines of the fingerprint recognition touch sensor. Accordingly, approximately 15876 (126×126) electrodes (sensing electrodes and drive electrodes) may be disposed in 10 mm×10 mm area of the fingerprint recognition touch sensor.

As illustrated in FIG. 3 and FIG. 4, in the fingerprint recognition touch sensor, a difference between the capacitance formed between the ridge of the fingerprint and the sensing electrode and the capacitance formed between valley and the sensing electrode may be very small. Hence, the fingerprint recognition touch sensor may utilize a touch sensing unit and a touch processing unit, which have a high signal-to-noise ratio (SNR), in order to distinguish the ridge and the valley of the fingerprint.

In addition, since the sensing electrode and the drive electrodes are densely disposed in the fingerprint recognition touch sensor, the number of nodes therein may be increased. Accordingly, a method of recognizing fingerprint patterns by sensing signals of the respective electrodes at high speed may be utilized.

In addition, in the fingerprint recognition touch sensor, a finger may touch all nodes of the fingerprint recognition touch sensor. If the human finger touches all the nodes, common noises, such as display noise, lamp noise, or charger noise, may be input to the fingerprint recognition touch sensor, by coupling capacitors formed between the human finger and the electrodes (sensing electrode and/or drive electrodes) of the fingerprint recognition touch sensor.

FIG. 5 is a diagram illustrating a touch sensor according to an exemplary embodiment of the present invention.

Referring to FIG. 5, the touch sensor according to the present embodiment may include a touch sensing unit 510. The touch sensing unit 510 includes multiple drive electrodes d1 to dn and multiple sensing electrodes s1 to sm.

The multiple drive electrodes d1 to dn may be arranged in parallel with each other in a horizontal direction (row direction) of the touch sensing unit 510, and the multiple sensing electrodes s1 to sm may be arranged in parallel with each other in a vertical direction (column direction) of the touch sensing unit 510. More particularly, the touch sensing unit 510 may be configured by an array structure, in which the multiple drive electrodes d1 to dn respectively intersect the multiple sensing electrodes s1 to sm.

Drive signal generation units 520 may apply predetermined drive signals to the respective drive electrodes d1 to dn. The predetermined drive signals may have predetermined voltages, for example, AC voltages. The drive signal generation units 520 may be code generators. In FIG. 5, the drive signal generation units 520 respectively apply the drive signals to the respective drive electrodes d1 to dn. However, one drive signal generation unit may alternatively apply the drive signals to multiple drive electrodes d1 to dn.

Respective sensing capacitances may be formed between the drive electrodes, to which the drive signals are applied, and the sensing electrodes corresponding thereto, according to the predetermined drive signals applied to the multiple drive electrodes d1 to dn. For example, an (1-1)^{th} sensing capacitance may be formed between the first drive electrode d1 and the first sensing electrode s1, and an (n-m)^{th} sensing capacitance may be formed between the n^{th} drive electrode dn and the m^{th} sensing electrode sm.

In addition, output values, which may be mixed values of the sensing electrodes formed between the drive electrodes d1 to dn and the sensing electrodes s1 to sm, may be output from the respective the sensing electrodes s1 to sm, as sensed output values. For example, the first sensing electrode s1 may output the output values corresponding to the magnitudes of the (1-1)^{th} sensing capacitance to the (1-n)^{th} sensing capacitance, which are formed between the first sensing electrode s1 and the first drive electrode d1, to the n^{th} drive electrode dn, as the first sensed output values. In addition, the m^{th} sensing electrode sm may output the m^{th} sensed output value.

In this case, in the touch sensor according to the present exemplary embodiment, the drive signals may be applied to the drive electrodes by a parallel driving method. More particularly, the drive signal generation unit 520 may simultaneously transmit modulated drive signals to the multiple drive electrodes d1 to dn. In addition, the output values, which may be mixed values of the sensing capacitances respectively formed between the drive electrodes d1 to dn and the sensing electrodes s1 to sm, may be output from the respective sensing electrodes s1 to sm as the sensed output values. Accordingly, the sensing electrodes s1 to sm may sense the multiple drive electrodes d1 to dn at one time. For example, at the first time, the first drive signal may be transmitted to the first drive electrode d1, and the second drive signal may be transmitted to the second drive electrode d2. In addition, the n^{th} drive signal may be transmitted to the n^{th} drive electrode dn. Accordingly, the (1-1)^{th} to (m-1)^{th} sensing capacitances may be formed between the first drive electrode d1 and the first to m^{th} sensing electrodes s1 to sm, and the (1-2)^{th} to (m-2)^{th} sensing capacitances may be formed between the second drive electrode d2 and the first to m^{th} sensing electrodes s1 to sm. In addition, the (1-n)^{th} to (m-n)^{th} sensing capacitances may be formed between the n^{th} drive electrode dn and the first to m^{th} sensing electrodes s1 to sm. Hence, at the first time, the sensed output values, which may be mixed values of the sensing capacitances respectively formed between the drive electrodes d1 to dn and the sensing electrodes s1 to sm, may be output. In addition, at the second time, the sensed output values, which may be mixed values of the sensing capacitances respectively formed between the drive electrodes d1 to dn and the sensing electrodes s1 to sm, may also be output.

At this time, if a touch event occurs at a predetermined region of the touch sensing unit 510, the sensing capacitance formed between the sensing electrode and the drive electrode disposed at the touched region may be changed. For example, if a touch event occurs at a location of the third sensing electrode s3 and the third drive electrode d3 of the touch sensing unit 510, the magnitude of the (3-3)^{th} sensing capacitance formed between the third sensing electrode s3 and the third drive electrode d3 may be changed. Accordingly, the third sensed output value, which is output from the third sensing electrode s3, may be changed, as compared to when a touch event does not occur.

In the touch sensor according to the present exemplary embodiment, each of the sensed output values, which are output from the sensing electrodes s1 to sm, and an output value of the sensing electrode adjacent thereto, may be input together to input terminals of a differential amplifier. For example, the second sensed output value of the second sensing electrode s2 and the third sensed output value of the third sensing electrode s3 may be input together to differential amplifiers 550 to 553. In addition, an occurrence of a touch may be determined by using a difference between the sensed output values of the two sensing electrodes.

At this time, in the touch sensor according to an exemplary embodiment of the present invention, in addition to the first to m^{th} sensed output values, which are output from the sensing electrodes s1 to sm, a reference value VREF may be input to the first differential amplifier 550. The touch sensor may determine whether or not the sensing electrode is touched by using the reference value VREF.

According to the present exemplary embodiment, the touch sensor may include analog multiplexers (mux) 530 to 535, charge amplifiers 540 to 545, and differential amplifiers 550 to 552.

The analog multiplexers 530 to 535 may receive at least two values of the sensed output values, which are output from the sensing electrodes s1 to sm and the reference value VREF, and output values corresponding to “0” or “1”. For example, the first analog multiplexer 530 may receive the reference value VREF and the first sensed output value, and output the reference value VREF corresponding to “0” and the first sensed output value corresponding to “1”. The second analog multiplexer 531 may receive the first sensed output value and the second sensed output value, and output the first sensed output value corresponding to “0” and the second sensed output value corresponding to “1”.

The charge amplifiers 540 to 545 may amplify output values of the analog multiplexers 530 to 535 and output a single amplified output value. For example, if the first charge amplifier 540 receives the first sensed output value, the first charge amplifier 540 may amplify the first sensed output value and output the first single amplified output value. According to exemplary embodiments of the present invention, if the analog multiplexers do not exist, the charge amplifiers 540 to 545 may alternatively amplify the received output values among the sensed output values, which are output from the sensing electrodes s1 to sm and the reference value VREF, and output the single amplified output value. As used herein, a value obtained by amplifying the reference value VREF is referred to as a reference single amplified output value, and the first to m^{th} sensed output values output from the sensing electrodes s1 to sm are referred to as first to m^{th} single amplified output values.

The differential amplifiers 550 to 552 may receive two values of the single amplified output values, which are output from the charge amplifiers 540 to 545, and output a value corresponding to a difference between the values, as a differential output value. For example, if the first differential amplifier 550 receives the reference single amplified output value and the first single amplified output value, the first differential amplifier 550 may output a value corresponding to a difference thereof as the first differential output value. According to an exemplary embodiment of the present invention, the differential amplifiers 550 to 552 may alternatively be differential gain amplifiers.

Differential output values output from the differential amplifiers 550 to 552 are input to a receiving unit (not illustrated), and a touch processing unit (touch control unit) (not illustrated) of the receiving unit may identify a touched point using the differential output value.

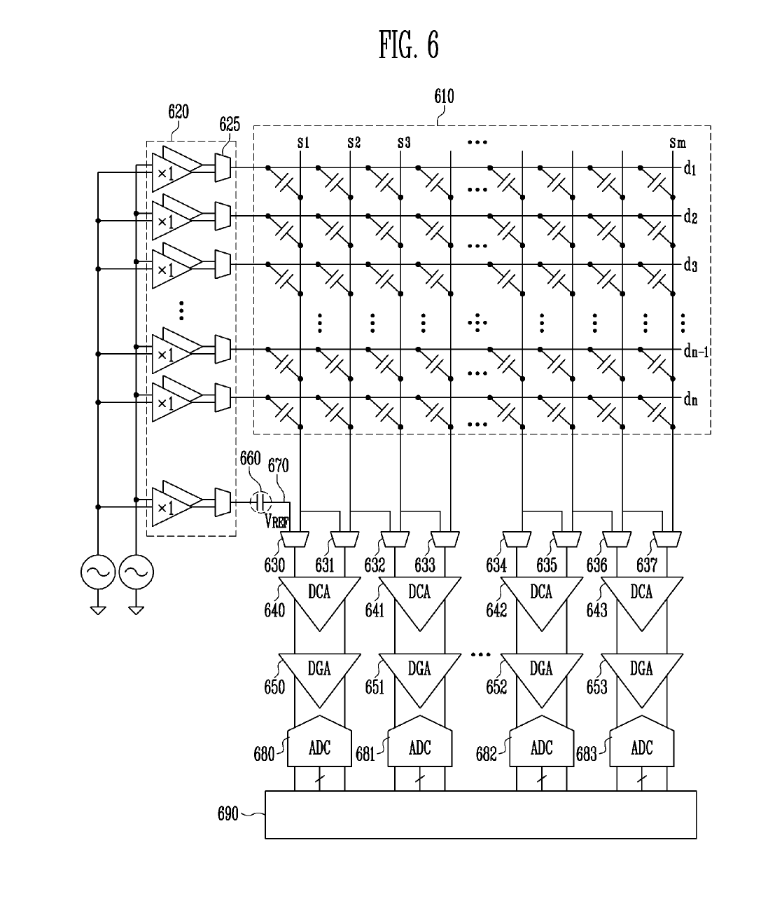

FIG. 6 is a diagram illustrating a touch sensor according to an exemplary embodiment of the present invention.

Referring to FIG. 6, the touch sensor according to the present exemplary embodiment may include a touch sensing unit 610. The touch sensing unit 610 includes the multiple drive electrodes d1 to dn and the multiple sensing electrodes s1 to sm.

The multiple drive electrodes d1 to dn may be arranged in parallel with each other in a horizontal direction (row direction) of the touch sensing unit 610, and the multiple sensing electrodes s1 to sm may be arranged in parallel with each other in a vertical direction (column direction) of the touch sensing unit 610. More particularly, the touch sensing unit 610 may be configured by an array structure, in which the multiple drive electrodes d1 to dn respectively intersect the multiple sensing electrodes s1 to sm.

Drive signal generation units 620 may apply predetermined drive signals to the respective drive electrodes d1 to dn. The predetermined drive signals may have predetermined voltages, for example, AC voltages. The drive signal generation units 620 may be code generators. In FIG. 6, the drive signal generation units 620 respectively apply the drive signals to the respective drive electrodes d1 to dn, however, one drive signal generation unit may alternatively apply the drive signals to multiple drive electrodes d1 to dn. The respective drive signal generation units 620 may receive reference code signals, modulate the reference code signals, and respectively generate drive signals for the respective drive electrodes d1 to dn. The drive signal generation unit 620 may further include a multiplexer 625.

Respective sensing capacitances may be formed between the drive electrodes to which the drive signals are applied, and the sensing electrodes corresponding thereto, according to the predetermined drive signals applied to the multiple drive electrodes d1 to dn. For example, an (1-1)^{th} sensing capacitance may be formed between the first drive electrode d1 and the first sensing electrode s1, and an (n-m)^{th} sensing capacitance may be formed between the n^{th} is drive electrode dn and the m^{th} sensing electrode sm.

Output values, which may be mixed values of the sensing electrodes formed between the drive electrodes d1 to dn and the sensing electrodes s1 to sm, may be output from the respective the sensing electrodes s1 to sm, as sensed output values. For example, the first sensing electrode s1 may output the output values corresponding to the magnitudes of the (1-1)^{th} sensing capacitance to the (1-n)^{th} sensing capacitance formed between the first sensing electrode s1 and the first drive electrode d1 to the n^{th} drive electrode dn, as the first sensed output values. In this manner, the m^{th} sensing electrode sm may output the m^{th} sensed output value.

In the touch sensor according to the present exemplary embodiment, the drive signals may be applied to the drive electrodes by a parallel driving method. More particularly, the drive signal generation unit 620 may simultaneously transmit modulated drive signals to the multiple drive electrodes d1 to dn. The output values, which may be mixed values of the sensing capacitances respectively formed between the drive electrodes d1 to dn and the sensing electrodes s1 to sm, may be output from the respective sensing electrodes s1 to sm, as the sensed output values. Accordingly, the sensing electrodes s1 to sm may sense the multiple drive electrodes d1 to dn at one time. For example, at the first time, the first drive signal may be transmitted to the first drive electrode d1, and the second drive signal may be transmitted to the second drive electrode d2. In addition, the n^{th} drive signal may be transmitted to the n^{th} drive electrode dn. Accordingly, the (1-1)^{th} to (m-1)^{th} sensing capacitances may be formed between the first drive electrode d1 and the first to m^{th} sensing electrodes s1 to sm, and the (1-2)^{th} to (m-2)^{th} sensing capacitances may be formed between the second drive electrode d2 and the first to m^{th} sensing electrodes s1 to sm. In addition, the (1-n)^{th} to (m-n)^{th} sensing capacitances may be formed between the n^{th} drive electrode dn and the first to m^{th} sensing electrodes s1 to sm. Hence, at the first time, the sensed output values, which may be mixed values of the sensing capacitances respectively formed between the drive electrodes d1 to dn and the sensing electrodes s1 to sm, may be output. In addition, at the second time, the sensed output values, which may be mixed values of the sensing capacitances respectively formed between the drive electrodes d1 to dn and the sensing electrodes s1 to sm, may also be output.

At this time, when a touch event occurs at a predetermined region of the touch sensing unit 610, the sensing capacitance formed between the sensing electrode and the drive electrode disposed at the touched region may be changed. For example, when a touch event occurs at a location of the third sensing electrode s3 and the third drive electrode d3 of the touch sensing unit 610, the magnitude of the (3-3)^{th} sensing capacitance formed between the third sensing electrode s3 and the third drive electrode d3 may be changed. Accordingly, the third sensed output value output from the third sensing electrode s3 may be changed, as compared to when a touch event does not occur.

In the touch sensor according to the an exemplary embodiment of the present invention, each of the sensed output values, which are output from the sensing electrodes s1 to sm, and an output value of the sensing electrode adjacent thereto may be input together to input terminals of a differential amplifier. For example, the second sensed output value of the second sensing electrode s2 and the third sensed output value of the third sensing electrode s3 may be input together to differential amplifiers 650 to 653. In addition, an occurrence of a touch may be determined by using a difference between the sensed output values of the two sensing electrodes.

At this time, in the touch sensor according to the present exemplary embodiment, in addition to the first to m^{th} sensed output values output from the sensing electrodes s1 to sm, a reference value VREF may be input to the first differential amplifier 650. The touch sensor may determine whether or not the sensing electrode is touched by using the reference value VREF.

The touch sensor may include analog multiplexers 630 to 637, charge amplifiers 640 to 643, and differential amplifiers 650 to 653, which are substantially similar to those of the touch sensor illustrated with reference to FIG. 5, and thus, duplicated description thereof will be omitted.

The touch sensor according to the present exemplary embodiment may further include a reference capacitor 660, which generates the reference value VREF. The reference capacitor 660 may be connected between the drive signal generation unit 620 and the first differential amplifier 650, convert a reference value generating signal output from the drive signal generation unit 620 into the reference value VREF, and output the reference value VREF. The touch sensor may further include a reference electrode 670, which supplies the reference output value VREF to the first differential amplifier 650.

The differential output values, which are output from the differential amplifiers 650 to 653, may be input to a touch processing unit (touch control unit) 690. The touch processing unit 690 may identify a touched point using the received values. At this time, the touch sensor according to the present exemplary embodiment may include analog-to-digital converters (ADC) 680 to 683 disposed between the differential amplifiers 650 to 653 and the touch processing unit 690. The analog-to-digital converters 680 to 683 may convert analog values output from the differential amplifiers 650 to 653 into digital signals, and output the digital signals to the touch processing unit 690. In FIG. 6, the analog-to-digital converters 680 to 683 are respectively connected to the differential amplifiers 650 to 653, however, an analog-to-digital converter may alternatively receive differential output values from the differential amplifiers 650 to 653.

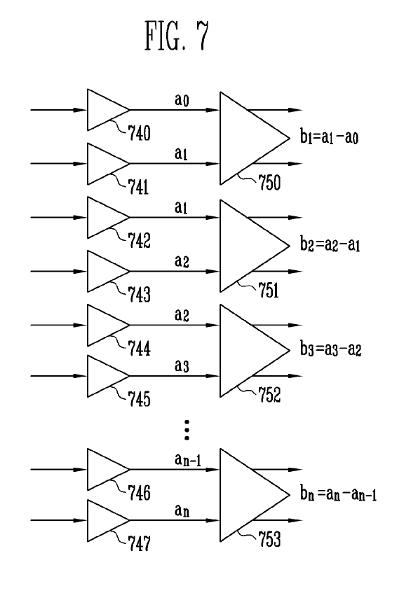

FIG. 7 is a diagram illustrating a differential sensing method according to an exemplary embodiment of the present invention.

Referring to FIG. 7, the touch sensor according to the present exemplary embodiment may include multiple charge amplifiers 740 to 747 and multiple differential amplifiers 750 to 753. The charge amplifiers 740 to 747 may amplify received output values among the sensed output values, which are output from sensing electrodes (not illustrated) of the touch sensor and a reference output value, and output single amplified output values. Each of the differential amplifiers 750 to 753 may receive two values of the single amplified output values output from the charge amplifiers 740 to 747, and output a value corresponding to a difference between the single amplified output values as a differential output value.

For example, the first charge amplifier 740 may receive the reference output value, amplify the reference output value, and output a reference single amplified output value a₀. The second charge amplifier 741 may receive the first sensed output value, amplify the first sensed output value, and output a first single amplified output value a₁. The first differential amplifier 750 may receive the reference single amplified output value a₀ output from the first charge amplifier 740 and the first single amplified output value a₁ output from the second charge amplifier 741, and output a first differential output value b₁ (e.g., a₁−a₀) corresponding to a difference therebetween.

The third charge amplifier 742 may receive the first sensed output value, amplify the first sensed output value, and output the first single amplified output value a₁. The fourth charge amplifier 743 may receive the second sensed output value, amplify the second sensed output value, and output a second single amplified output value a₂. The second differential amplifier 751 may receive the first single amplified output value a₁ output from the third charge amplifier 742 and the second single amplified output value a₂ output from the fourth charge amplifier 743, and output a second differential output value b₂ (e.g., a₂−a₁) corresponding to a difference therebetween.

In this manner, the n^{th} differential amplifier 753 may receive the (n-1)^{th} single amplified output value aₙ₋₁ output from the (2n-1)^{th} charge amplifier 746 and the n^{th} single amplified output value aₙ output from the 2n^{th} charge amplifier 747, and output an n^{th} differential output value bₙ (e.g., aₙ−aₙ₋₁) corresponding to a difference therebetween.

More particularly, signals respectively input to the differential amplifiers 750 to 753 may be output as a differential output value corresponding to a difference between the related single amplified output value and the single amplified output value of a sensing electrode adjacent thereto, as represented by Equation 1. For example, the n^{th} differential output value bₙ output from the n^{th} differential amplifier may be a difference between the n^{th} single amplified output value aₙ and the (n-1)^{th} single amplified output value aₙ₋₁.

$$\begin{matrix}{b}_{1} = {a}_{1} - {a}_{0} \\ {b}_{2} = {a}_{2} - {a}_{1} \\ {b}_{3} = {a}_{3} - {a}_{2} \\ … \\ {b}_{n} = {a}_{n} - {a}_{n - 1}\end{matrix} . \qquad Equation 1$$

The respective single amplified output values may be represented as the differential output values and the reference single amplified output value a₀, using Equation 1, and the result may be represented by Equation 2.

$$\begin{matrix}\begin{matrix}{a}_{1} = {a}_{0} + {b}_{1} \\ {a}_{2} = {a}_{1} + {b}_{2} = {a}_{0} + ( {b}_{1} + {b}_{2} ) \\ {a}_{3} = {a}_{2} + {b}_{3} = {a}_{0} + ( {b}_{1} + {b}_{2} + {b}_{3} ) \\ … \\ {a}_{n} = {a}_{0} + ( {b}_{1} + … + {b}_{n} )\end{matrix} . & Equation 2\end{matrix}$$

For example, the n^{th} single amplified output value aₙ may be represented by the sum of the reference single amplified output value a₀ and the first to n^{th} differential output values (aₙ=a₀+(b₁+ . . . +bₙ)).

A touch processing unit (not illustrated) may obtain the respective single amplified output values aₖ, using the reference single amplified output value a₀ and the differential output values b₁ to bₖ, according to Equation 3.

$${a}_{k} = {a}_{0} + ( {b}_{1} + … + {b}_{k} ) = {a}_{0} + {\sum }_{n = 1}^{k} {b}_{n} \qquad Equation 3$$

While the touch sensor illustrated with reference to FIG. 7 includes the multiple charge amplifiers 740 to 747, the touch sensor may alternatively not include the multiple charge amplifiers 740 to 747. In this case, the reference single amplified output value a₀ may correspond to the reference value VREF, which is described with reference to FIG. 5 and FIG. 6, and the first to n^{th} single amplified output values a₁ to aₙ may correspond to the first to n^{th} sensed output values, which are described with reference to FIG. 5 and FIG. 6.

More particularly, the first differential amplifier 750 may receive the reference output value a₀ and the first sensed output value a₁, and the n^{th} differential amplifier 753 may receive the (n-1)^{th} sensed output value aₙ₋₁ and the n^{th} sensed output value aₙ. The first differential output value b₁ may be a difference b₁ (e.g., a₁−a₀) between the first sensed output value a₁ and the reference output value a₀, and the n^{th} differential output value bₙ may be a difference bₙ (e.g., aₙ−aₙ₋₁) between the n^{th} sensed output value aₙ and the (n-1)^{th} sensed output value aₙ₋₁. In addition, the n^{th} sensed output value aₙ may be represented by the sum of the reference output value a₀ and the first to n^{th} differential output values (aₙ=a₀+(b₁+ . . . +bₙ)).

In this manner, when the touch sensor according to the present exemplary embodiment is driven by a differential amplification sensing method, the single ended output values of the respective sensing electrodes, that is, the sensed output values (or single amplified output values) of the respective sensing electrodes may be recovered, as represented by Equation 3. Hence, a multi-touch recognition, in which all nodes of the touch sensor are touched for fingerprint recognition, may be implemented. In addition, changes of the respective sensing capacitances may be recognized by using the reference output value and the differential output values. In addition, the output may be confirmed by a differential method, and thus, the common noise may be removed.

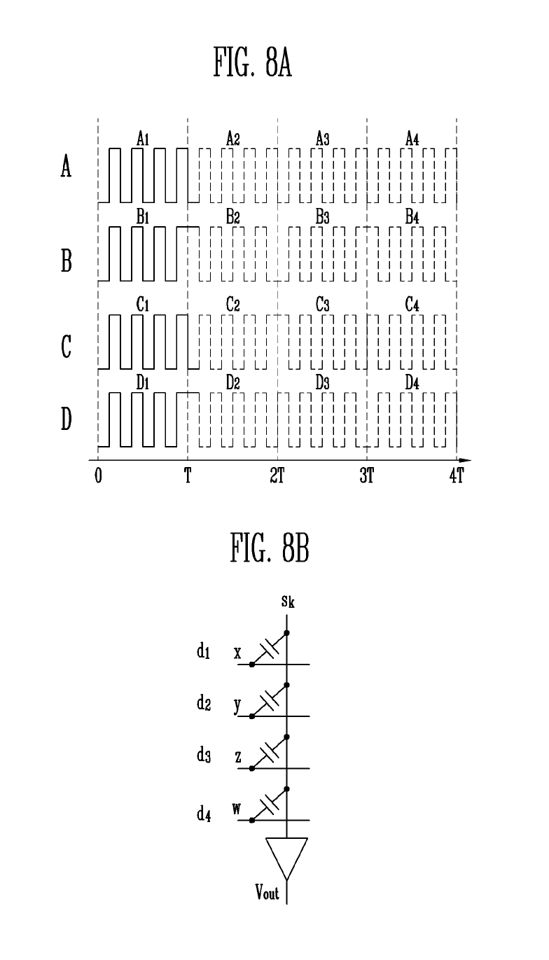

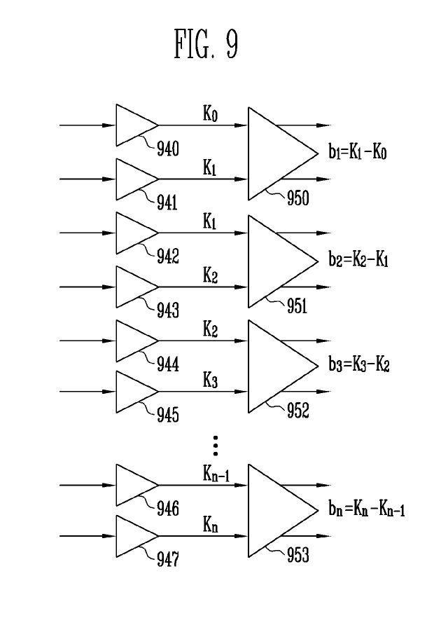

FIGS. 8A and 8B are diagrams illustrating a parallel driving method according to an exemplary embodiment of the present invention. FIG. 9 is a diagram illustrating a differential parallel sensing method according to an exemplary embodiment of the present invention.

Referring to FIGS. 8A and 8B, parallel drive signals A, B, C, and D are input to four drive electrodes. The first drive signal A may be input to the first drive electrode, the second drive signal B may be input to the second drive electrode, the third drive signal C may be input to the third drive electrode, and the fourth drive signal D may be input to the fourth drive electrode. The respective drive signals A, B, C, and D may be simultaneously input to the respective drive electrodes in the entire time periods. As used herein, a signal input to the first drive electrode is referred to as an (1-1)^{th} drive signal A1, a signal input to the second drive electrode is referred to as an (2-1)^{th} drive signal B1, a signal input to the third drive electrode is referred to as an (3-1)^{th} drive signal C1, and a signal input to the fourth drive electrode is referred to as an (4-1)^{th} drive signal D1, during a time period T1 (e.g., 0 to T). The drive signals input during a time period T2 (e.g., T to 2T), a time period T3 (e.g., 2T to 3T), and a time period T4 (e.g., 3T to 4T) are referred as in the same manner as above.

Referring to FIG. 8B, first to fourth drive electrodes d1 to d4, to which drive signals illustrated in FIG. 8B are input, may be disposed in a horizontal direction of a touch sensor (not illustrated), and a k^{th} sensing electrode sk may be disposed in a direction perpendicular thereto. A first sensing capacitance “x” may be formed between the first drive electrode d1 and the k^{th} sensing electrode sk, a second sensing capacitance “y” may be formed between the second drive electrode d2 and the k^{th} sensing electrode sk, a third sensing capacitance “z” may be formed between the third drive electrode d3 and the k^{th} sensing electrode sk, and a fourth sensing capacitance “w” may be formed between the fourth drive electrode d4 and the k^{th} sensing electrode sk.

In this manner, k^{th} sensed output values (K; K1, K2, K3, K4) output from the k^{th} sensing electrode sk during the respective time periods T1, T2, T3, and T4 may be represented by following Equation 4.

T₁:A₁x+B₁y+C₁z+D₁w=K₁

T₂:A₂x+B₂y+C₂Z+D₂w=L₂

T₃:A₃x+B₃Y+C₃Z+D₃w=K₃

T₄:A₄x+B₄y+C₄Z+D₄w=K₄ Equation 4

At this time, the sensing capacitances x, y, z, and w formed between the sensing electrode sk and the first to fourth drive electrodes d1 to d4 may be modulated and demodulated by using the drive signals (H; A, B, C, D) and the k^{th} sensed output values (K; K1, K2, K3, K4). More particularly, a touch processing unit (not illustrated) may obtain the sensing capacitances x, y, z, and w formed between the k^{th} sensing electrode sk and the first to fourth drive electrodes d1 to d4, using following Equation 5 and Equation 6.

$$\begin{matrix}H = ( \begin{matrix}{A}_{1} & {B}_{1} & {C}_{1} & {D}_{1} \\ {A}_{2} & {B}_{2} & {C}_{2} & {D}_{2} \\ {A}_{3} & {B}_{3} & {C}_{3} & {D}_{3} \\ {A}_{4} & {B}_{4} & {C}_{4} & {D}_{4}\end{matrix} ) , X = ( \begin{matrix}x \\ y \\ z \\ w\end{matrix} ) , K = ( \begin{matrix}{K}_{1} \\ {K}_{2} \\ {K}_{3} \\ {K}_{4}\end{matrix} ) & Equation 5 \\ H \times X = K ⇔ X = {H}^{- 1} \times K & Equation 6\end{matrix}$$

More particularly, the sensing capacitances formed between the k^{th} sensing electrode sk and the first to fourth drive electrodes d1 to d4 may be obtained by multiplying inverse matrix of the drive signals (H; A, B, C, D) by the k^{th} sensed output values (K; K1, K2, K3, K4).

When the parallel driving method is used, multiple signals may be simultaneously transmitted, and thus, the SNR of the parallel driving method may be higher than an SNR of the time-interleaving method, during a predetermine time period, which may provide a faster processing. Hence, if the number of nodes is large in the fingerprint recognition touch sensor, and a touch event occurs in multiple sensing electrodes, the touch on each nodes may be rapid1y recognized.

Next, referring to FIG. 9, the touch sensor according to the present exemplary embodiment may include multiple charge amplifiers 940 to 947 and multiple differential amplifiers 950 to 953. The charge amplifiers 940 to 947 may amplify received output values, among the sensed output values output from sensing electrodes (not illustrated) of the touch sensor, and a reference output value, and output single amplified output values. Each of the differential amplifiers 950 to 953 may receive two values of the single amplified output values, which are output from the charge amplifiers 940 to 947, and output a value corresponding to a difference between the single amplified output values as a differential output value.

For example, the first charge amplifier 940 may receive the reference output value, amplify the reference output value, and output a reference single amplified output value K₀. The second charge amplifier 941 may receive the first sensed output value, amplify the first sensed output value, and output a first single amplified output value K₁. The first differential amplifier 950 may receive the reference single amplified output value a₀, which is output from the first charge amplifier 940, and the first single amplified output value K₁, which is output from the second charge amplifier 941, and output a first differential output value b₁ (e.g., K₁−K₀) corresponding to a difference therebetween.

According to an exemplary embodiment of the present invention, the touch sensor may alternatively not include the multiple charge amplifiers 940 to 947. In this case, the reference single amplified output value K₀ may correspond to the reference value VREF, which is described with reference to FIG. 5 and FIG. 6, and the first to n^{th} single amplified output values K₁ to Kₙ may correspond to the first to n^{th} sensed output values which are described with reference to FIG. 5 and FIG. 6.

The k^{th} single sensed output value Kₖ of the first to n^{th} single amplified output values K₁ to Kₙ may correspond to the k^{th} sensed output value, which is output from the k^{th} sensing electrode sk, if the parallel drive signals A, B, C, and D are input to the drive electrodes d1 to d4. More particularly, if the parallel drive signals are input, the first to n^{th} single amplified output values k₁ to Kₙ may correspond to the sensed output values output from the respective sensing electrodes.

At this time, signals which are respectively input to the differential amplifiers 950 to 953 may be output as a differential output value corresponding to a difference between the related single amplified output value and the single amplified output value of a sensing electrode adjacent thereto, as represented by following Equation 7.

$$\begin{matrix}\begin{matrix}{b}_{1} = {K}_{1} - {K}_{0} \\ {b}_{2} = {K}_{2} - {K}_{1} \\ {b}_{3} = {K}_{3} - {K}_{2} \\ … \\ {b}_{n} = {K}_{n} - {K}_{n - 1}\end{matrix} & Equation 7\end{matrix}$$

The respective single amplified output values may be represented as the differential output values and the reference single amplified output value K₀, using Equation 7, and the result may be represented as following Equation 8.

$$\begin{matrix}\begin{matrix}{K}_{1} = {K}_{0} + {b}_{1} \\ {K}_{2} = {K}_{1} + {b}_{2} = {K}_{0} + ( {b}_{1} + {b}_{2} ) \\ {K}_{3} = {K}_{2} + {b}_{3} = {K}_{0} + ( {b}_{1} + {b}_{2} + {b}_{3} ) \\ … \\ {K}_{n} = {K}_{0} + ( {b}_{1} + … + {b}_{n} )\end{matrix} & Equation 8\end{matrix}$$

For example, the n^{th} single amplified output value Kₙ may be represented by the sum of the reference single amplified output value K₀ and the first to n^{th} differential output values (Kₙ=K₀+(b₁+ . . . +bₙ)).

A touch processing unit (not illustrated) may obtain the respective single amplified output values K₁, using the reference single amplified output value K₀ and the differential output values b₁ to bₖ, according to following Equation 9. Here, K₁ may denote a sensed output value of the l^{th} sensing electrode of the sensing electrodes, K₀ may denote a reference output value, and bₙ may denote a differential output value of the n^{th} differential amplifier of the differential amplifiers.

$${K}_{l} = {K}_{0} + ( {b}_{1} + … + {b}_{l} ) = {K}_{0} + {\sum }_{n = 1}^{l} {b}_{n} \qquad Equation 9$$

As described above, if the touch sensor according to the present exemplary embodiment uses a differential parallel driving method, a differential parallel structure system may be implemented by applying a differential algorithm of following Equation 10 and a parallel algorithm of following Equation 11.

$$\begin{matrix}{K}_{l} = {K}_{0} + ( {b}_{1} + … + {b}_{l} ) = {K}_{0} + {\sum }_{n = 1}^{l} {b}_{n} & Equation 10 \\ H \times X = K ⇔ X = {H}^{- 1} \times K & Equation 11\end{matrix}$$

More particularly, the sensed output values may be calculated by using the reference output value K₀ and the differential output values, using Equation 10, and values of the respective sensing capacitances may be calculated by using the sensed output values, which are calculated by Equation 10 and the drive signals, using Equation 11.

A fingerprint recognition touch sensor may have a dense disposition of sensing electrodes and drive electrodes, and may have a small amount of change of capacitance. In addition, the fingerprint recognition touch sensor may have a large number of the sensing electrodes and the drive electrodes, which may increase the number of nodes and sensing time for fingerprint recognition.

In the fingerprint recognition touch sensor according to exemplary embodiments of the present invention, the sensing capacitance is changed depending on the ridge and the valley of a fingerprint, and the amount of change in the sensing capacitance may be very small. As such, the touch sensor according to the exemplary embodiments of the present invention may use a parallel driving method and a differential sensing method, in order to sense the small amount of change and to rapidly sense multiple nodes. More particularly, multiple signals are simultaneously transmitted in the parallel driving method, and thus, a higher SNR may be obtained by the parallel driving method, as compared to a time-interleaving method, during a predetermined amount of time. When a finger touches the entire sensing electrodes of the touch sensor for fingerprint recognition, a common noise, such as lamp noise that is generated at a node that a finger touches, may be removed by using the differential sensing method.

In addition, according to exemplary embodiments of the present invention, a touch sensor having a high signal to noise ratio (SNR), a method of recognizing a fingerprint pattern by sensing signals of each electrode at a high speed, and a touch sensor which performs correct touch recognition by removing common noise such as, display noise, lamp noise, or charger noise, may be provided.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A touch sensor, comprising:
a touch sensing unit comprising drive electrodes and sensing electrodes;
a drive signal generation unit configured to apply parallel drive signals to the drive electrodes;
differential amplifiers configured to receive a reference output value and sensed output values output from the sensing electrodes according to the parallel drive signals; and
a touch processing unit configured to determine an occurrence of a touch according to differential output values of the differential amplifiers.

2. The touch sensor of claim 1, further comprising at least one multiplexer disposed between the sensing electrodes and the differential amplifiers,
wherein the at least one multiplexer is configured to time-share the sensed output values output from the sensing electrodes and the reference output value, and transmit the time-shared s values to the differential amplifiers.

3. The touch sensor of claim 1, further comprising at least one charge amplifier disposed between the sensing electrodes and the differential amplifiers,
wherein the at least one charge amplifier is configured to amplify the sensed output values output from the multiple sensing electrodes, and output the amplified values.

4. The touch sensor of claim 1, further comprising an analog-to-digital converter disposed between the sensing electrodes and the touch processing unit,
wherein the analog-to-digital converter is configured to convert analog differential output values output from the differential amplifiers into digital values, and output the digital values.

5. The touch sensor of claim 1, further comprising a reference capacitor disposed between the drive signal generation unit and the differential amplifiers,
wherein the reference capacitor is configured to convert a reference value generation signal output from the drive signal generation unit into the reference output value.

6. The touch sensor of claim 5, further comprising a reference electrode disposed between the reference capacitor and the differential amplifiers,
wherein the reference electrode is configured to supply the reference output value to the differential amplifiers.

7. The touch sensor of claim 1, wherein the touch processing unit is configured to demodulate the sensed output values using the reference output value and the differential output values.

8. The touch sensor of claim 7, wherein the touch processing unit demodulates the sensed output values using a following equation:
$${K}_{l} = {K}_{0} + ( {b}_{1} + … + {b}_{l} ) = {K}_{0} + {\sum }_{n = 1}^{l} {b}_{n} ,$$
where, K₁ denotes the sensed output value of an 1^{th} sensing electrode of the sensing electrodes, K₀ denotes the reference output value, and bₙ denotes the differential output value of an n^{th} differential amplifier of the differential amplifiers.

9. The touch sensor of claim 7, wherein the touch processing unit is configured to calculate sensing capacitances of the drive electrodes corresponding to the sensing electrodes, using the parallel drive signals and the sensed output values.

10. The touch sensor of claim 9, wherein the touch processing unit is configured to calculate the sensing capacitances by multiplying an inverse matrix of the parallel drive signals by the sensed output values.

11. A method of driving a touch sensor, the method comprising:
inputting parallel drive signals to drive electrodes disposed on a touch sensing unit;
outputting sensed output values according to the parallel drive signals and a reference output value to differential amplifies; and
determining an occurrence of a touch according to differential output values of the differential amplifiers.

12. The method of claim 11, wherein outputting the sensed output values comprises:
converting a reference value generation signal into the reference output value; and
outputting the reference output value to the amplifier.

13. The method of claim 11, wherein determining the occurrence of a touch comprises demodulating the sensed output values using the reference output value and the differential output values.

14. The method of claim 13, wherein demodulating the sensed output values comprises demodulating the sensed output values by using a following equation:
$${K}_{l} = {K}_{0} + ( {b}_{1} + … + {b}_{l} ) = {K}_{0} + {\sum }_{n = 1}^{l} {b}_{n} ,$$
where, K₁ denotes the sensed output value of an 1^{th} sensing electrode of the sensing electrodes, K₀ denotes the reference output value, and bₙ denotes the differential output value of an n^{th} differential amplifier of the differential amplifiers.

15. The method of claim 13, wherein determining the occurrence of a touch further comprises calculating sensing capacitances of the drive electrodes corresponding to sensing electrodes, using the parallel drive signals and the sensed output values.
